(19) United States
(12) Patent Application Publication
(10) Pub. No.: US 2021/0203230 A1
(43) Pub. Date: Jul. 1, 2021

(54) SWITCHING CONVERTER WITH VOLTAGE AND CURRENT DUAL-LOOP CONTROL AND CONTROL METHOD THEREOF

(71) Applicant: Chengdu Monolithic Power Systems Co., Ltd., Chengdu (CN)

(72) Inventor: Lei Li, Chengdu (CN)

(21) Appl. No.: 17/125,790

(22) Filed: Dec. 17, 2020

(30) Foreign Application Priority Data
Dec. 31, 2019 (CN) 201911413420.1

(51) Int. Cl. H02M 3/158; H02M 1/088; H02M 3/157

(52) U.S. Cl. CPC H02M 3/158; H02M 3/157; H02M 1/088

(57) ABSTRACT

Voltage and current dual-loop control circuit for controlling a switching converter and associated control method. The voltage and current dual-loop control circuit has a voltage control circuit and a current control circuit. The voltage control circuit regulates the switching converter to convert an input voltage to an output voltage. The current control circuit limits and regulates a maximum value of an output current of the switching converter.

### CROSS-REFERENCE TO RELATED APPLICATION

This application claims the benefit of CN application No. 201911413420.1, filed on Dec. 31, 2019, and incorporated herein by reference.

### TECHNICAL FIELD

The present invention generally refers to electrical circuit, and more particularly but not exclusively refers to switching converter with voltage and current dual-loop control and associated control method.

### BACKGROUND

In power conversion applications, voltage control scheme is widely adopted in DC/DC switching converter. But in some applications, such as a USB interface circuit application, current may also need to be regulated in a voltage controlled switching converter. Traditionally, in a voltage and current dual-loop control scheme, the current control loop is usually introduced into the voltage control loop which may induce the whole voltage and current dual-loop control system to have a narrow bandwidth and a slow dynamic response.

Therefore, it is desired to have a new voltage and current dual-loop control scheme for switching converters to improve the bandwidth and the dynamic response.

### SUMMARY

Embodiments of the present invention are directed to a voltage and current dual-loop control circuit for controlling a switching converter having a high side switch and a low side switch. The voltage and current dual-loop control circuit may comprise: a voltage control circuit, configured to receive a voltage feedback signal indicative of an output voltage signal of the switching converter to generate a first control signal; and a current control circuit, configured to receive a current feedback signal indicative of an output current signal of the switching converter, and further configured to generate a current threshold signal based on the current feedback signal; wherein when an inductor current signal flowing through an output inductor of the switching converter is larger than the current threshold signal, the high side switch is turned off; and wherein when the inductor current signal is decreased to the current threshold signal, the first control signal is configured to control the high side switch and the low side switch to perform on and off switching.

Embodiments of the present invention are directed to a switching converter, comprising: a switching circuit, comprising a high side switch and a low side switch; a voltage control circuit, configured to receive a voltage feedback signal indicative of an output voltage signal of the switching converter to generate a first control signal; a current control circuit, configured to receive a current feedback signal indicative of an output current signal of the switching converter, and further configured to generate a current threshold signal based on the current feedback signal; wherein when an inductor current signal flowing through an output inductor of the switching converter is larger than the current threshold signal, the high side switch is turned off; and wherein when the inductor current signal is decreased to the current threshold signal, the first control signal is configured to control the high side switch and the low side switch to perform on and off switching.

Embodiments of the present invention are directed to a voltage and current dual-loop control method for a switching converter having a high side switch and a low side switch, comprising: generating a first control signal based on a voltage feedback signal indicative of an output voltage signal of the switching converter; generating a current threshold signal based on a current feedback signal indicative of an output current signal of the switching converter; determining whether an inductor current signal flowing through an output inductor of the switching converter is decreased to the current threshold signal when the low side switch is turned on; controlling the high side switch off when the inductor current signal is larger than the current threshold signal; and controlling the high side switch off when the inductor current signal is larger than the current threshold signal; and adopting the first control signal to control the high side switch and the low side switch to perform on and off switching when the inductor current signal is decreased to the current threshold signal.

### BRIEF DESCRIPTION OF THE DRAWINGS

Non-limiting and non-exhaustive embodiments are described with reference to the following drawings.

FIG. 1 illustrates a block diagram of a switching converter 100 in accordance with an embodiment of the present invention;

FIG. 2 schematically illustrates the voltage control circuit 21 in accordance with an embodiment of the present invention;

FIG. 3 schematically illustrates the on time generator 201 of FIG. 2 in accordance with an embodiment of the present invention;

FIG. 4 illustrates a block diagram of the current control circuit 22 of FIG. 1 in accordance with an embodiment of the present invention;

FIG. 5 schematically illustrates the current control circuit 22 of FIG. 1 in accordance with an embodiment of the present invention;

FIG. 6 schematically illustrates the logic circuit 23 of FIG. 1 in accordance with an embodiment of the present invention;

FIG. 7 schematically illustrates a switching converter 700 in accordance with an embodiment of the present invention;

FIG. 8 illustrates an operation waveform diagram 800 illustrating operation of the switching converter 700 in accordance with an embodiment of the present invention;

FIG. 9 illustrates an operation waveform diagram 900 illustrating operation of the switching converter 700 in accordance with another embodiment of the present invention;

FIG. 10 illustrates a voltage and current dual-loop control method 1000 for a switching converter in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

The phrase “couple” includes direct connection and indirect connection. Indirect connection includes connection through conductor which has resistance and/or parasitic parameters such as inductance and capacitance, or connection through diode, and so on.

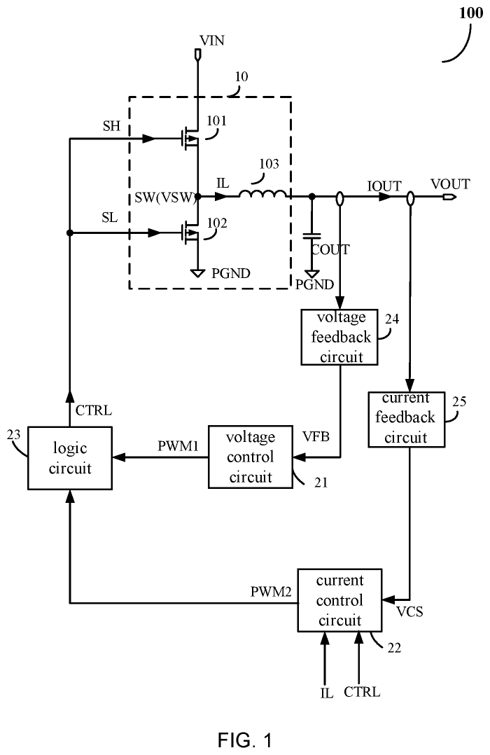

FIG. 1 illustrates a block diagram of a switching converter 100 in accordance with an embodiment of the present invention. As shown in FIG. 1, the switching converter 100 may comprise a switching circuit 10, an output capacitor COUT and a control circuit. The switching circuit 10 may comprise at least one controllable switch. The control circuit may be configured to generate a control signal CTRL based on a voltage feedback signal VFB indicative of an output voltage signal VOUT of the switching converter 100 and a current feedback signal VCS indicative of an output current signal IOUT of the switching converter 100, wherein the control signal CTRL may be configured to control the at least one controllable switch to perform on and off switching so as to regulate the output voltage signal VOUT and the output current signal IOUT.

In the exemplary embodiment of FIG. 1, the switching circuit 10 may be illustrated to have a BUCK topology comprising a high side switch 101, a low side switch 102 and an output inductor 103, wherein the high side switch 101 and the low side switch 102 are illustrated as Metal Oxide Semiconductor Field Effect Transistors (“MOSFETs”) in FIG. 1. Each of the high side switch 101 and the low side switch 102 has a source, a drain and a gate. The drain of the high side switch 101 may be coupled to an input terminal of the switching converter 100 for receiving an input voltage signal VIN. The source of the high side switch 101 may be coupled to the drain of the low side switch 102 and forma common connection node SW. The source of the low side switch 102 is connected to a logic ground. The output inductor 103 may be coupled between the common connection node SW and an output terminal of the switching converter 100. When the high side switch 101 is turned on and the low side switch 102 is turned off, an inductor current signal IL flowing through the output inductor 103 increases linearly. When the high side switch 101 is turned off and the low side switch 102 is turned on, the inductor current signal IL is freewheeling through the low side switch 102. The output capacitor COUT may be connected between the output terminal of the switching converter 100 and the logic ground so as to provide the output voltage signal VOUT to a load.

As can be appreciated, whereas the high side switch 101 and the low side switch 102 are illustrated as MOSFETs in FIG. 1, in other embodiment, the high side switch 101 and the low side switch 102 may comprise other suitable semiconductor devices such as Junction Field Effect Transistors (“JFETs”), Insulated Gate Bipolar Translators (“IGBTs”) etc. Likewise, although the switching circuit 10 is illustrated to have a BUCK topology in FIG. 1, in other embodiment, the switching circuit 10 may comprise other suitable topology, such as BOOST, FORWAD or FLYBACK topologies etc.

In the exemplary embodiment of FIG. 1, the control circuit may comprise a voltage control circuit 21, a current control circuit 22 and a logic circuit 23.

In an embodiment, the voltage control circuit 21 may be configured to receive the voltage feedback signal VFB, and further configured to generate a first control signal PWM1 based on the voltage feedback signal VFB. The first control signal PWM1 may be configured to control the high side switch 101 and the low side switch 102 to perform on and off switching. In an embodiment, the first control signal PWM1 may comprise a logic signal having an active state and an inactive state. When the voltage feedback signal VFB is lower than a reference voltage, the first control signal PWM1 may be at the active state (e.g., a logic high state). When the voltage feedback signal VFB is higher than the reference voltage, the first control signal PWM1 may be at the inactive state (e.g., a logic low state).

In an embodiment, the current control circuit 22 may be configured to receive the current feedback signal VCS, the inductor current signal IL and the control signal CTRL. The current control circuit 22 may be configured to generate a current threshold signal based on the current feedback signal VCS. In an embodiment, the current control circuit 22 may further be configured to vary the current threshold signal in accordance with change in the current feedback signal VCS. For instance, in an embodiment, the current threshold signal may be decreased with increase in the current feedback signal VCS, i.e., the larger the current feedback signal VCS is, the smaller the current threshold signal is (for example in magnitude in an embodiment, but this is not intended to be limiting). When the low side switch 102 is turned on by the control signal CTRL, the inductor current signal IL begins to decrease. Meanwhile, the current control circuit 22 may be further configured to compare the inductor current signal IL with the current threshold signal to generate a second control signal PWM2. In an embodiment, the second control signal PWM2 may comprise a logic signal having an active state and an inactive state. When the inductor current signal IL is larger than the current threshold signal, the second control signal PWM2 may be at the inactive state to keep the high side switch 101 off. When the inductor current signal IL is decreased to the current threshold signal or to be smaller than the current threshold signal, the second control signal PWM2 may be at the active state which enables the first control signal PWM1 to control the high side switch 101 and the low side switch 102. That is to say, the first control signal PWM1 is enabled to control the high side switch 101 and the low side switch 102 to perform on and off switching only when the inductor current signal IL is decreased to the current threshold signal or to be lower than the current threshold signal.

In an embodiment, the logic circuit 23 may comprise a first input terminal configured to receive the first control signal PWM1, a second input terminal configured to receive the second control signal PWM2, and an output terminal. The logic circuit 23 may be configured to conduct a logic operation to the first control signal PWM1 and the second control signal PWM2 to generate the control signal CTRL. In an embodiment, the control signal CTRL may comprise a high side control signal SH and a low side control signal SL to respectively control the high side switch 101 and the low side switch 102 on and off. The high side control signal SH and the low side control signal SL may be logic signals each having an active state (e.g., logic high) and an inactive state (e.g., logic low). In an embodiment, if the second control signal PWM2 is in the active state while the first control signal PWM1 is in the active state, the high side switch 101 is turned on by the high side control signal SH and the low side switch 102 is turned off by the low side control signal SL. If the second control signal PWM2 is in the active state and the first control signal PWM1 is in the inactive state, the high side switch 101 is turned off by the high side control signal SH and the low side switch 102 is turned on by the low side control signal SL. In other embodiment, if the second control signal PWM2 is in the inactive state, the high side switch 101 is kept off whatever state the first control signal PWM1 is in.

In the exemplary embodiment of FIG. 1, the control circuit may further comprise a voltage feedback circuit 24 and a current feedback circuit 25. The voltage feedback circuit 24 may be configured to receive the output voltage signal VOUT to generate the voltage feedback signal VFB. The current feedback circuit 25 may be configured to sense the output current signal IOUT to generate the current feedback signal VCS. In other embodiments, the current feedback circuit 25 can also be configured to sense other suitable current signals which can be indicative of output current signal IOUT to generate the current feedback signal VCS, e.g., the inductor current signal IL.

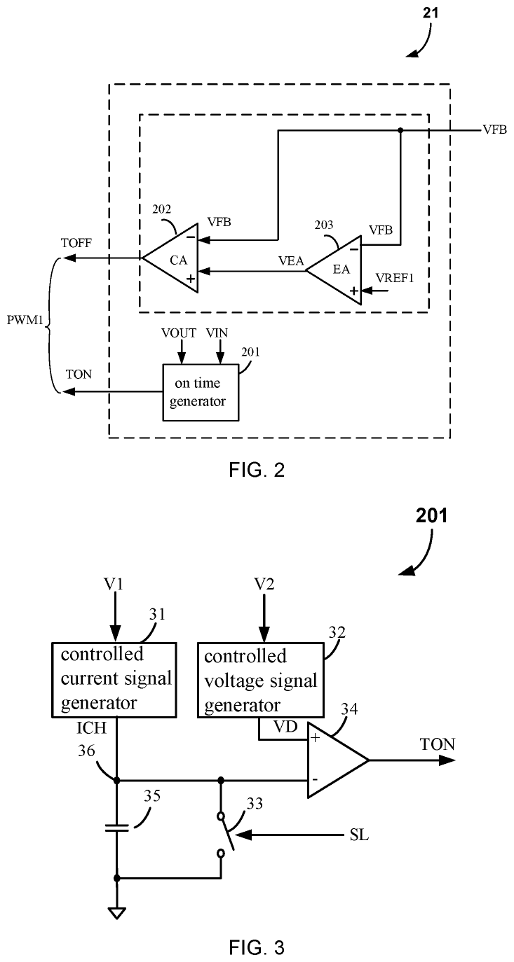

FIG. 2 schematically illustrates the voltage control circuit 21 in accordance with an embodiment of the present invention. As shown in FIG. 2, the voltage control circuit 21 is illustrated as a Constant On Time (COT) control module comprising an on time generator 201 and a voltage comparing circuit. In the exemplary embodiment of FIG. 2, the first control signal PWM1 may comprise an on time control signal TON and a comparison signal TOFF.

In the exemplary embodiment of FIG. 2, the on time generator 201 may be configured to receive the input voltage signal VIN and the output voltage signal VOUT to generate the on time control signal TON which may be a logic signal having a logic high state and a logic low state. In an embodiment, when the on time control signal TON is changed from the logic low state to the logic high state while the second control signal PWM2 is in the active state, the high side switch 101 is turned off and the low side switch 102 is turned on.

In the exemplary embodiment of FIG. 2, the voltage comparing circuit may comprise an operational amplifier 202 and a voltage comparator 203. The operational amplifier 202 may comprise a first input terminal configured to receive the voltage feedback signal VFB, a second input terminal configured to receive a first voltage reference signal VREF1, and an output terminal. The operational amplifier 202 may be configured to compare the voltage feedback signal VFB with the first reference voltage signal VREF1 to generate an amplifier output signal VEA at its output terminal, wherein the amplifier output signal VEA may be indicative of a difference between the voltage feedback signal VFB and the first reference voltage signal VREF1. In the exemplary embodiment of FIG. 2, the voltage comparator 203 may comprise a first input terminal configured to receive the voltage feedback signal VFB, a second input terminal configured to receive the amplifier output signal VEA, and an output terminal. The voltage comparator 203 may be configured to compare the voltage feedback signal VFB with the amplifier output signal VEA to generate the comparison signal TOFF at its output terminal, wherein the comparison signal TOFF may be a logic signal having a logic high state and a logic low state. In an embodiment, when the voltage feedback signal VFB is decreased to reach the amplifier output signal VEA, the comparison signal TOFF is at the logic high state to turn the high side switch 101 on. In an embodiment, the on time control signal TON is configured to determine the on time (i.e. a duration during which the high side switch 101 is on) of the high side switch 101 and the comparison signal TOFF is configured to determine the on moment (i.e. the moment at which the high side switch 101 is turned/switched on) of the high side switch 101.

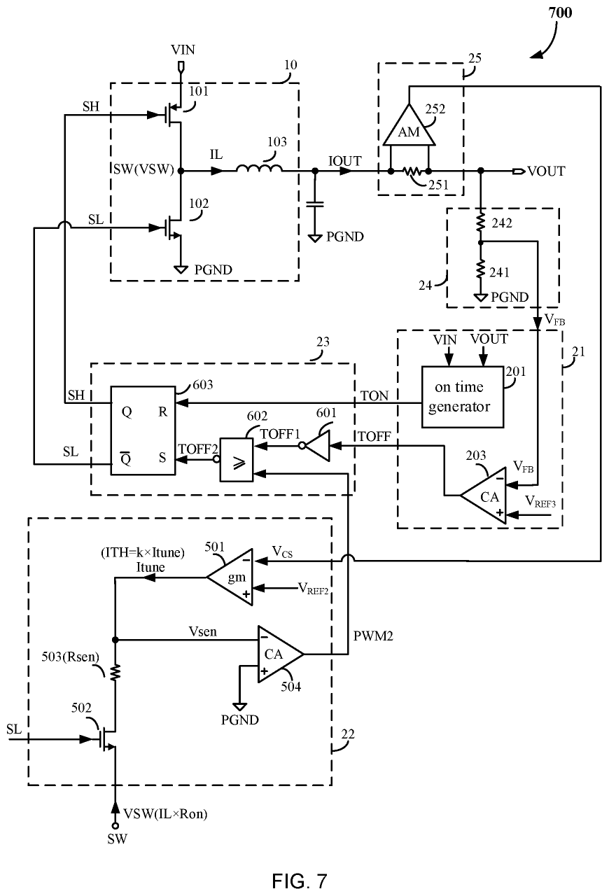

In other embodiments, the voltage comparing circuit may only comprise the voltage comparator 203 excluding the operational amplifier 202. In such an exemplary application, the voltage comparator 203 may be configured to compare the voltage feedback signal VFB with a voltage reference signal (e.g., the voltage reference signal VREF3 illustrated in FIG. 7) to generate the comparison signal TOFF.

It should be understood by those of ordinary skill in the art that the schematic diagram of the voltage control circuit 21 of FIG. 2 is an embodiment for illustrating a COT control scheme. In alternative embodiments, the voltage control circuit may comprise other suitable modules and elements for realizing different voltage control schemes to generate the first control signal PWM1 to regulate the output voltage signal VOUT.

FIG. 3 schematically illustrates the on time generator 201 of FIG. 2 in accordance with an embodiment of the present invention. In the exemplary embodiment of FIG. 3, the on time generator 201 may comprise a controlled current signal generator 31, a controlled voltage signal generator 32, a reset switch 33, a comparator 34, a capacitor 35, and a node 36.

The controlled current signal generator 31 may be configured to receive a first voltage signal V1 to generate a charging current signal ICH. The capacitor 35 may be connected between the controlled current signal generator 31 and the logic ground. The common connection of the controlled current signal generator 31 and the capacitor 35 may be referred to as the node 36. The reset switch 33 may be coupled between the node 36 and the logic ground. The controlled voltage signal generator 32 may be configured to receive a second voltage signal V2 to generate a controlled voltage signal VD. The comparator 34 may have a first input terminal configured to receive the controlled voltage signal VD, a second input terminal coupled to the node 36 to receive a voltage signal across the capacitor 35, and an output terminal. The comparator 34 may be configured to compare the controlled voltage signal VD with the voltage signal across the capacitor 35 to generate the on time control signal TON at its output terminal. In an embodiment, the reset switch 33 is controlled by the high side control signal SH. In such an application, when the high side control signal SH is logic high (i.e., the high side switch 101 is turned on), the reset switch 33 is turned off so that the charging current signal ICH may begin to charge the capacitor 35. When the high side control signal SH is logic low, the reset switch 33 is turned on so that the capacitor 35 is discharged through the reset switch 33.

In the exemplary embodiment of FIG. 3, the first voltage signal V1 and the second voltage signal V2 may relate to or depend on the topology that the switching circuit 10 has. In an embodiment, the switching circuit 10 may have a BUCK topology, the on time control signal TON is proportional to the output voltage signal VOUT and inversely proportional to the input voltage signal VIN. In such a condition, the first voltage signal V1 may comprise the input voltage signal VIN, and the charging current signal ICH may be proportional to the input voltage signal VIN; the second voltage signal V2 may comprise the output voltage signal VOUT, and the controlled voltage signal VD may be proportional to the output voltage signal VOUT.

In an alternative embodiment, the switching circuit 10 may have a BOOST topology, the on time control signal TON is proportional to the difference of the output voltage signal VOUT and the input voltage signal VIN (i.e., VOUT-VIN), and inversely proportional to the output voltage signal VOUT. In such a condition, the first voltage signal V1 may comprise the output voltage signal VOUT, and the charging current signal ICH may be proportional to the output voltage signal VOUT; the second voltage signal V2 may comprise the input voltage signal VIN and the output voltage signal VOUT, and the controlled voltage signal VD may be proportional to the difference of the output voltage signal VOUT and the input voltage signal VIN (i.e., VOUT-VIN). As can be appreciated, the embodiments illustrated in FIG. 2 and FIG. 3 are the dedicated exemplary embodiments in which the on time control signal TON is relevant with the input voltage signal VIN and the output voltage signal VOUT, in other embodiments, the on time control signal TON may be irrelevant with the input voltage signal VIN and the output voltage signal VOUT. For example, both the first voltage signal V1 and the second voltage signal V2 may be a default constant voltage signal, e.g., a power supply voltage signal VCC, which is used to generate the on time control signal TON.

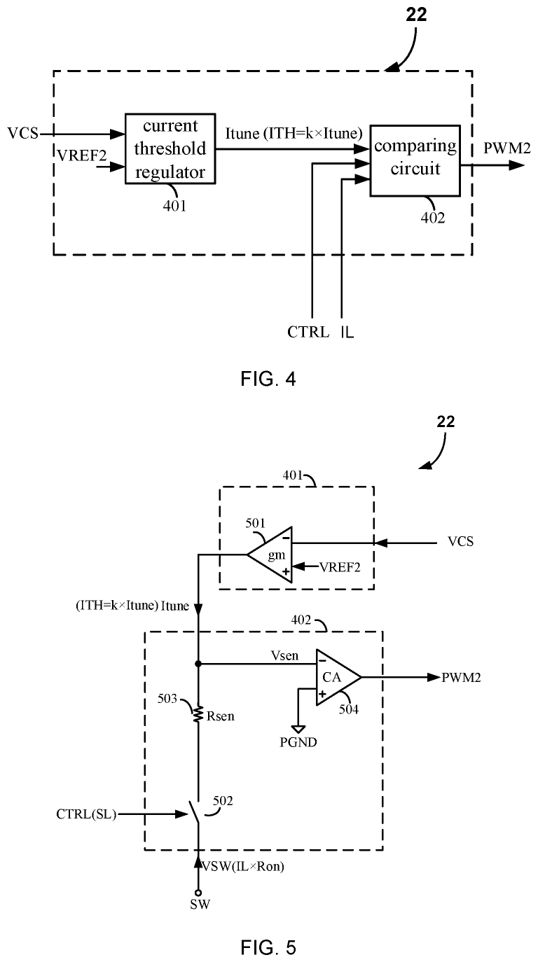

FIG. 4 illustrates a block diagram of the current control circuit 22 of FIG. 1 in accordance with an embodiment of the present invention. In the exemplary embodiment of FIG. 4, the current control circuit 22 may comprise a current threshold regulator 401 and a threshold comparing circuit 402.

In the exemplary embodiment of FIG. 4, the current threshold regulator 401 may be configured to receive the current feedback signal VCS, and further configured to compare the current feedback signal VCS with a current reference signal VREF2 to generate a threshold regulating signal Itune. The threshold regulating signal Itune which is indicative of the difference of the current feedback signal VCS and the current reference signal VREF2 may be configured to regulate a current threshold signal ITH. In an embodiment, the current threshold signal ITH is equal to K times of the threshold regulating signal Itune, i.e., ITH=K×Itune, wherein K is a proportional coefficient being relative to a resistance of a resistor (e.g., resistor 503 shown in FIG. 5) of the threshold comparing circuit 402 and the on resistance Ron of the low side switch 102.

In the exemplary embodiment of FIG. 4, the threshold comparing circuit 402 may be configured to receive the threshold regulating signal Itune, the control signal CTRL and the inductor current signal IL. When the low side switch 102 is turned on, the threshold comparing circuit 402 is configured to generate the current threshold signal ITH based on the threshold regulating signal Itune, and further configured to compare the inductor current signal IL with the current threshold signal ITH to generate the second control signal PWM2. In an embodiment, the control signal CTRL may comprise the low side control signal SL.

FIG. 5 schematically illustrates the current control circuit 22 of FIG. 1 in accordance with an embodiment of the present invention. As shown in FIG. 5, the current threshold regulator 401 may comprise an operational transconductance amplifier (OTA) 501. The OTA 501 may comprise a first input terminal receiving the current feedback signal VCS, a second input terminal receiving the current reference signal VREF2, and an output terminal. The OTA 501 may be configured to compare the current feedback signal VCS with the current reference signal VREF2 to generate the threshold regulating signal Itune. In an embodiment, the threshold regulating signal Itune is a current signal indicative of the difference of the current feedback signal VCS and the current reference signal VREF2.

In the exemplary embodiment of FIG. 5, the threshold comparing circuit 402 may comprise a switch 502, a resistor 503 of a resistance Rsen and a comparator 504.

The switch 502 may have a first terminal, a second terminal coupled to a common connection SW of the high side switch 101 and the low side switch 102 to receive a switching node voltage signal VSW, and a control terminal receiving the control signal CTRL. The resistor 503 may have a first terminal coupled to an output terminal of the current threshold regulator 401 to receive the threshold regulating signal Itune, a second terminal couple to the first terminal of the switch 502. In view that the switching node voltage signal VSW is equal to the on resistance Ron of the low side switch 102 multiplied by the inductor current signal IL once the low side switch 102 is turned on, the switching node voltage signal VSW can be indicative of the inductor current signal IL. In the exemplary embodiment of FIG. 5, the control signal CTRL may be the low side control signal SL. In an embodiment, the resistance of the resistor 503 is proportional to the on resistance Ron of the low side switch 102. In an embodiment, the resistance of the resistor 503 is equal to a few hundred of kilo-ohms.

The comparator 504 may comprise a first input terminal coupling to the first terminal of the resistor 503, a second input terminal connecting to the logic ground, and an output terminal. The comparator 504 may be configured to compare a voltage signal Vsen on the first terminal of the resistor 503 with a voltage signal PGND which is indicative of the voltage of the logic ground of the converter 100 to generate the second control signal PWM2 at its output terminal. When both the low side switch 102 and switch 502 are turned on in response to the active state of the low side control signal SL, the voltage signal Vsen on the first terminal of the resistor 503 can be calculated by an equation of Vsen=Itune×Rsen−IL×Ron+PGND.

In the exemplary embodiment of FIG. 5, when the low side switch 102 is turned on, the inductor current signal IL is decreased from a peak value where the voltage signal Vsen on the first terminal of the resistor 503 is lower than the voltage signal PGND so that the second control signal PWM2 is in the active state. When the inductor current signal IL is decreased to the current threshold signal ITH, the state of the second control signal PWM2 is changed from the active state to the inactive state. At this time, the current threshold signal ITH can be calculated by an equation of ITH=Rsen×Itune/Ron.

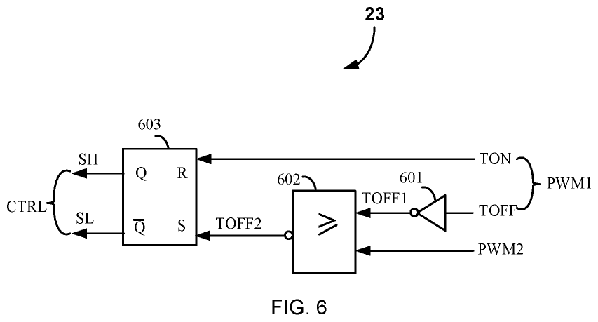

FIG. 6 schematically illustrates the logic circuit 23 of FIG. 1 in accordance with an embodiment of the present invention. In the exemplary embodiment of FIG. 6, the first control signal PWM1 may comprise the comparison signal TOFF and the on time control signal TON. As shown in FIG. 6, the logic circuit 23 may comprise a NOT gate 601, a NOR gate 602 and a flip-flop 603. The NOT gate 601 may be configured to receive the comparison signal TOFF, and further configured to conduct a logic operation to the comparison signal TOFF to generate the first logic signal TOFF1. The NOR gate 602 may be configured to receive the first logic signal TOFF1 and the second control signal PWM2, and further configured to conduct a logic operation to the first logic signal TOFF1 and the second control signal PWM2 to generate a second logic signal TOFF2. The flip-flop 603 may comprise a set terminal S receiving the second logic signal TOFF2, a reset terminal R receiving the on time control signal TON, a first output terminal Q providing the high side control signal SH and a second output terminal Q̅ providing the low side control signal SL.

FIG. 7 schematically illustrates a switching converter 700 in accordance with an embodiment of the present invention. In the exemplary embodiment of FIG. 7, the voltage feedback circuit 24 is illustrated to have a resistor 241 and a resistor 242, wherein the resistor 241 and the resistor 242 are connected between an output terminal of the switching converter 700 and a logic ground in series, and the voltage signal on the common connection of the resistor 241 and the resistor 242 is the voltage feedback signal VFB. The current feedback circuit 25 may comprise a sensing resistor 251 and an operational amplifier 252. The sensing resistor 251 is connected between the output inductor 103 and the output terminal of the switching converter 700. The operational amplifier 252 may comprise two input terminals respectively coupled to the two terminals of the sensing resistor 251, and be configured to sense and amplify the voltage across the sensing resistor 251 to generate the current feedback signal VCS.

In the exemplary embodiment of FIG. 7, the voltage control circuit 21 is illustrated to comprise the on time generator 201 and the voltage comparator 203. The architecture of the on time generator 201 of FIG. 7 can adopt the architecture of the on time generator 201 illustrated in FIG. 3. The voltage comparator 203 may be configured to receive the voltage feedback signal VFB and a voltage reference signal VREF3, and further configured to compare the voltage feedback signal VFB with the voltage reference signal VREF3 to generate the comparison signal TOFF. In the exemplary embodiment of FIG. 7, architectures of the current control circuit 22 and the logic circuit 23 are respectively illustrated as same as those of FIG. 5 and FIG. 6, thus both of them are not described again for simplicity.

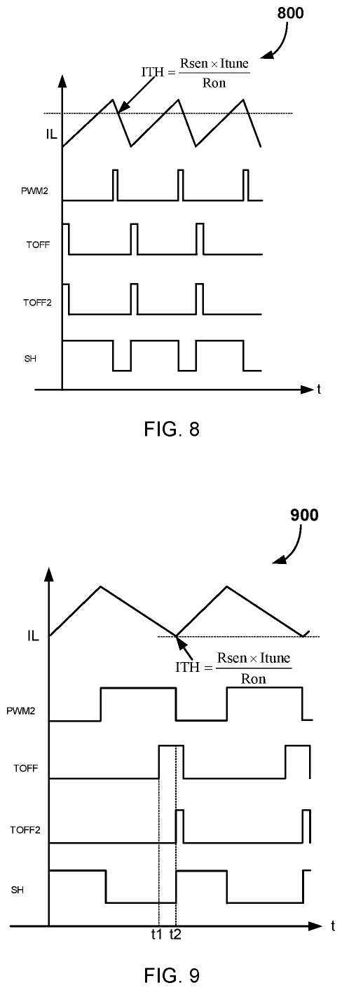

FIG. 8 illustrates an operation waveform diagram 800 illustrating operation of the switching converter 700 in accordance with an embodiment of the present invention. FIG. 9 illustrates an operation waveform diagram 900 illustrating operation of the switching converter 700 in accordance with another embodiment of the present invention. As shown in FIGS. 8 and 9, the diagrams 800 and 900 illustrate the inductor current signal IL, the second control signal PWM2, the comparison signal TOFF, the second logic signal TOFF2 and the high side control signal SH from top-to-bottom.

In the following, the operation process of the switching converter 700 will be described in detail with reference to FIGS. 7-9.

When the low-side switch 102 and the switch 502 are turned on, the inductor current signal IL is deceased from the peak value where the voltage signal Vsen on the first terminal of the resistor 503 is lower than the voltage signal PGND so that the second control signal PWM2 is in the active state. At this time, whether the comparison signal TOFF is logic high or logic low, the high side switch 101 is kept off in response to the active state of the second control signal PWM2. When the inductor current signal IL is decreased to the current threshold signal ITH, the second control signal PWM2 is changed from the active state to the inactive state, the state of the second logic signal TOFF2 is determined by the state of the comparison signal TOFF. As shown in FIG. 8, during the logic high state of the second control signal PWM2, the second logic signal TOFF2 keeps logic low state to turn the high side switch 101 off until the second control signal PWM2 changes to logic low and the comparison signal TOFF is logic high. As also shown in the waveform 900 of FIG. 9, during the logic high state of the second control signal PWM2, the second logic signal TOFF2 keeps the logic low state to turn off the high side switch 101 even the comparison signal TOFF is logic high (see the period from t1 to t2). That is to say, the high side switch 101 is not turned on unless the valley value of the inductor current IL is decreased to be equal to the current threshold signal ITH even the voltage feedback signal VFB is lower than the first voltage reference signal VREF1. Therefore, the maximum of the output current signal IOUT is limited, which may reduce the possibility of destruction to the switching converter.

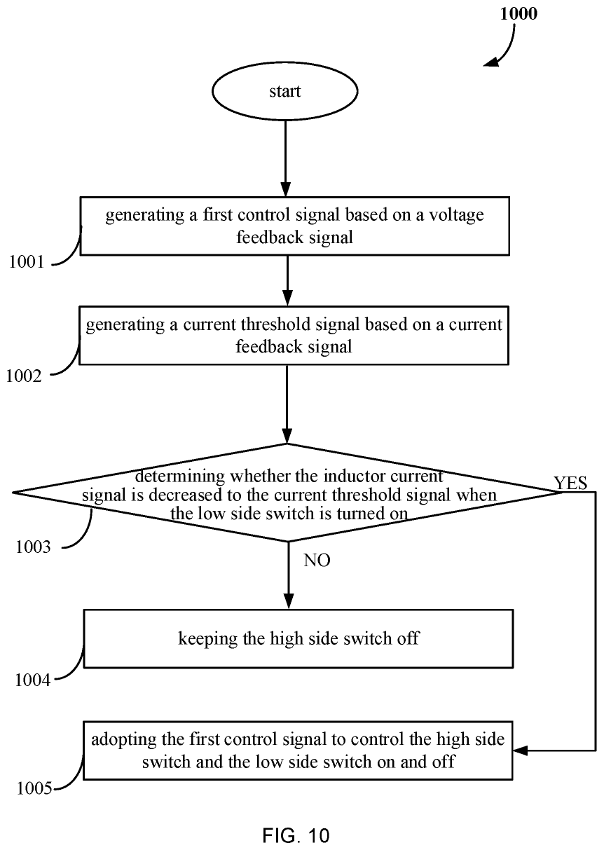

FIG. 10 illustrates a voltage and current dual-loop control method 1000 for a switching converter in accordance with an embodiment of the present invention. The voltage and current dual-loop control method 1000 can be carried out in the embodiments of this application mentioned above with reference to FIGS. 1-7. The voltage and current dual-loop control method 1000 may comprise steps 1001-1005.

In step 1001, generating a first control signal PWM1 based on a voltage feedback signal VFB, wherein the voltage feedback signal VFB is indicative of the output voltage signal VOUT of the switching converter.

In step 1002, generating a current threshold signal ITH based on a current feedback signal VCS, wherein the current feedback signal VCS is indicative of the output current signal IOUT of the switching converter.

In step 1003, when the low side switch 102 is turned on, determining whether the inductor current signal IL is decreased to the current threshold signal ITH. If the inductor current signal IL is larger than the current threshold signal ITH, go to step 1004, otherwise, continue with step 1005.

In step 1004, keeping the high side switch 101 off.

In step 1005, when the inductor current signal IL is decreased to the current threshold signal ITH, adopting the first control signal PWM1 to control the high side switch 101 and the low side switch 102 to perform on and off switching.

It should be understood that in the exemplary embodiment of FIG. 10, although the step 1002 is arranged after the step 1001, actually, the step 1001 and the step 1002 may happen synchronously.

Obviously many modifications and variations of the present invention are possible in light of the above teachings. It is therefore to be understood that within the scope of the appended claims the invention may be practiced otherwise than as specifically described. It should be understood, of course, the foregoing invention relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What we claim is:

1. A voltage and current dual-loop control circuit for controlling a switching converter, the voltage and current dual-loop control circuit comprising:
a voltage control circuit, configured to receive a voltage feedback signal indicative of an output voltage signal of the switching converter to generate a first control signal; and
a current control circuit, configured to receive a current feedback signal indicative of an output current signal of the switching converter to generate a current threshold signal; wherein
when an inductor current signal flowing through an output inductor of the switching converter is larger than the current threshold signal, a high side switch of the switching converter is turned off; and wherein
when the inductor current signal is decreased to the current threshold signal, the first control signal is configured to control the high side switch and a low side switch of the switching to perform on and off switching.

2. The voltage and current dual-loop control circuit of claim 1, wherein the current control circuit is further configured to receive the inductor current signal, and further configured to compare the inductor current signal with the current threshold signal to generate a second control signal when the low side switch is turned on; and wherein when the inductor current signal is larger than the current threshold signal, the second control signal is configured to turn off the high side switch.

3. The voltage and current dual-loop control circuit of claim 1, wherein the current control circuit is further configured to vary the current threshold signal in accordance with change in the current feedback signal.

4. The voltage and current dual-loop control circuit of claim 2, wherein the current control circuit comprises:
a current threshold regulator, configured to receive the current feedback signal, and further configured to compare the current feedback signal with a current reference signal to generate a threshold regulating signal; and
a first comparing circuit, configured to receive the threshold regulating signal and the inductor current signal, and configured to generate the current threshold signal based on the threshold regulating signal, and wherein when the low side switch is turned on, the first comparing circuit is further configured to compare the inductor current signal with the current threshold signal to generate the second control signal.

5. The voltage and current dual-loop control circuit of claim 4, wherein the current threshold regulator comprises:
an operational transconductance amplifier, configured to receive the current feedback signal and the current reference signal, and further configured to compare the current feedback signal with the current reference signal to generate the threshold regulating signal.

6. The voltage and current dual-loop control circuit of claim 4, wherein the first comparing circuit comprises:
a resistor, having a first terminal coupled to an output terminal of the current threshold regulator to receive the threshold regulating signal, and a second terminal;
a switch, having a first terminal coupled to the second terminal of the resistor, a second terminal coupled to a common connection of the high side switch and the low side switch, a control terminal configured to receive a low side control signal, wherein the low side control signal is configured to control the low side switch; and
a comparator, having a first input terminal coupled to the first terminal of the resistor, a second input terminal connected to a logic ground, and an output terminal, wherein the comparator is configured to compare a voltage signal on the first terminal of the resistor with a voltage signal indicative of a voltage of the logic ground to generate the second control signal at its output terminal.

7. The voltage and current dual-loop control circuit of claim 2, further comprising:
a logic circuit, configured to receive the first control signal and the second control signal, and further configured to conduct a logic operation to the first control signal and the second control signal to generate a switch control signal, wherein the switch control signal is configured to control the high side switch and the low side switch to perform on and off switching.

8. The voltage and current dual-loop control circuit of claim 7, wherein the first control signal comprises an on time control signal and a comparison signal, and wherein the voltage control circuit comprises:
an on time generator, configured to receive the input voltage signal and the output voltage signal to generate the on time control signal; and
a second comparing circuit, configured to receive the voltage feedback signal and a voltage reference signal, and further configured to compare the voltage feedback signal with the voltage reference signal to generate the comparison signal.

9. The voltage and current dual-loop control circuit of claim 8, wherein the logic circuit comprises:
a NOT gate, configured to receive the comparison signal, and further configured to conduct a logic operation to the comparison signal to generate a first logic signal;
a NOR gate, configured to receive the first logic signal and the second control signal, and further configured to conduct a logic operation to the first logic signal and the second control signal to generate a second logic signal; and
a flip-flop, having a set terminal configured to receive the second logic signal, a reset terminal configured to receive the on time control signal, and an output terminal configured to provide the switch control signal.

10. The voltage and current dual-loop control circuit of claim 1, wherein the current threshold signal is decreased with increase in the current feedback signal.

11. A switching converter, comprising:
a switching circuit, comprising a high side switch and a low side switch;
a voltage control circuit, configured to receive a voltage feedback signal indicative of an output voltage signal of the switching converter to generate a first control signal;
a current control circuit, configured to receive a current feedback signal indicative of an output current signal of the switching converter, and further configured to generate a current threshold signal based on the current feedback signal; wherein
when an inductor current signal flowing through an output inductor of the switching converter is larger than the current threshold signal, the high side switch is turned off; and wherein
when the inductor current signal is decreased to the current threshold signal, the first control signal is configured to control the high side switch and the low side switch to perform on and off switching.

12. The switching converter of claim 11, wherein the current control circuit is further configured to receive the inductor current signal, and configured to compare the inductor current signal with the current threshold signal to generate a second control signal when the low side switch is turned on; and wherein when the inductor current signal is larger than the current threshold signal, the second control signal is configured to turn off the high side switch.

13. The switching converter of claim 11, wherein the current threshold signal is varied with change in accordance with the current feedback signal.

14. The switching converter of claim 11, wherein the current threshold signal is decreased with increase in the current feedback signal.

15. A voltage and current dual-loop control method for a switching converter, comprising:
generating a first control signal based on a voltage feedback signal indicative of an output voltage signal of the switching converter;
generating a current threshold signal based on a current feedback signal indicative of an output current signal of the switching converter;
determining whether an inductor current signal flowing through an output inductor of the switching converter is decreased to the current threshold signal when a low side switch of the switching converter is turned on;
maintaining a high side switch of the switching converter off when the inductor current signal is larger than the current threshold signal; and
adopting the first control signal to control the high side switch and the low side switch to perform on and off switching when the inductor current signal is decreased to the current threshold signal.

16. The voltage and current dual-loop control method of claim 15, wherein the current threshold signal is varied in accordance with change in the current feedback signal.

17. The voltage and current dual-loop control method of claim 15, wherein the current threshold signal is decreased with increase in the current feedback signal.

18. The voltage and current dual-loop control method of claim 15, wherein determining whether the inductor current signal is decreased to the current threshold signal comprises comparing the inductor current signal with the current threshold signal to generate a second control signal through; and wherein maintaining the high side switch off when the inductor current signal is larger than the current threshold signal comprises using the second control signal to turn the high side switch off.
